(19) United States
(12) Patent Application Publication
(10) Pub. No.: US 2009/0221204 A1
(43) Pub. Date: Sep. 3, 2009

(54) Biodegradable needle punch carpet

(75) Inventor: Dirk De Saedeleir, Lebbeke (BE)

Correspondence Address: BACON & THOMAS, PLLC, 625 SLATERS LANE, FOURTH FLOOR, ALEXANDRIA, VA, 22314-1176, US

(73) Assignee: DS TEXTILE PLATFORM NV

(21) Appl. No.: 11/991,172

(22) PCT Filed: Jun. 22, 2006
(86) PCT No.: PCT/EP2006/006004

§ 371 Date: Mar. 12, 2009

(30) Foreign Application Priority Data
Aug. 31, 2005 (EP) 05018883.8

(51) Int. Cl. D04H 1/08; B32B 7/08; B32B 7/10; B32B 37/24; B32B 37/00

(52) U.S. Cl. 442/324; 156/91; 156/320; 156/283

(57) ABSTRACT

The present invention provides needle punch carpets for intensive use, as well as methods of manufacture of the same. The needle punch carpets are substantially, and preferably completely biodegradable. A needle punch carpet according to the present invention comprises a needle felt and at least one backing layer, wherein both the needle felt and the at least one backing layer comprise at least 90%, preferably at least 95%, more preferably at least 98% and most preferred 100% of polymeric biodegradable material, for example poly (L-lactic acid) and poly (D-lactic acid), respectively.

### TECHNICAL FIELD OF THE INVENTION

The present invention relates to the field of needle punch carpet floor coverings, in particular to such carpets which are almost fully biodegradable and preferably fully biodegradable as well as to methods of manufacture of the same.

### BACKGROUND OF THE INVENTION

Needle punch carpet is an assembly of fiber webs which are compacted and interlocked. In conventional production of needle punch carpets, fibres which are to be included in the needle-punch carpet are carded to a pre-determined surface weight. Fibres conventionally used for needle punch carpet are synthetic fibres such as polypropylene, polyester, nylon and acryl fibres. The carded fibre is thereafter mechanically bonded in a needling machine, where large beds of steel needles are moved in and out of the loose fiber to create large sheets of felt. The felt needle has rough, notched edges that force the fibre down causing it to entangle with other fibres. As a result, a needle felt is obtained. The needle felt is chemically bonded with an organic binder of the latex type at the back. This gives the carpet a high durability. Conventionally used binders are SBR, polyacrylate or polyacrylonitrile.

Needle punch carpet obtained according to the above process can be purchased at relatively low-cost, and is used mainly for indoor or outdoor carpet which undergoes an intensive wearing, such as during events, fairs, in shops, horeca or schools, where a large number of people come by and walk or even drive over the carpet.

After intensive use e.g. during an event or a fair, carpets are dirty and/or damaged, and are to be destroyed. Tufted carpets, which comprise biodegradable polymer filaments, are known from EP1130149A1. Tufted carpets are rather expansive as compared to nonwoven, needle punched carpets, which cost is usually too high to be useful for event carpets.

It is a disadvantage of the presently known needle punch carpets that, as soon as they become useless, they make a bulky waste, which is difficult to dispose of. Because the heat quantity generated in connection with incineration of the used carpets is large when the carpet is to be disposed of by incineration, the service life of the incinerator may be shortened and toxic gases or black smoke may be generated or alternatively expensive collection and incineration procedures must be carried out.

### SUMMARY OF THE INVENTION

It is an object of the present invention to provide carpets for intensive use, in particular to such carpets as well as to methods of manufacture of the same.

Needle punch carpets in accordance with the present invention can be highly durable so that they are suitable for intensive use such as during fairs, but which, after the event, are easily disposed of.

The above objective is accomplished by a method and device according to the present invention. A solution to these problems is to make substantially the complete carpet biodegradable.

In a first aspect, the present invention provides a needle punch carpet comprising a needle felt and at least one backing layer, wherein both the needle felt and the at least one backing layer comprise at least 90%, preferably at least 95%, more preferably at least 98% or even at least 99% and most preferred 100% by weight of polymeric biodegradable material. The needle felt may be a multi layer needle felt.

The needle felt may comprise, or substantially consist of, a first polymeric biodegradable material and the backing layer may comprise, or substantially consist, of a second polymeric biodegradable material, the first polymeric biodegradable material having at least one physical property which is different from the corresponding physical property of the second polymeric biodegradable material. The first and the second polymeric biodegradable material may for example have different melting points. The melting point T1 of the first polymeric biodegradable material is higher than the melting point T2 of the second polymeric biodegradable material, more particular; T1 is at least 10° C. higher than T2.

According to embodiments of the present invention, the backing layer may be provided by melting polymeric biodegradable powder.

According to embodiments of the present invention, the difference T1−T2 may be larger or equal to 25° C. or even larger or equal to 30° C.

According to embodiments of the present invention, the backing layer may have a surface weight of 30 g/m² to 1030 g/m².

According to embodiments of the present invention, the needle felt has an average thickness T, the backing layer may be present up to a depth in the needle felt, which depth is in the rage of 10% to 40% of the average thickness T.

In a preferred embodiment, the needle felt may be made of poly (L-lactic acid). At least one of the at least one backing layer may be made of poly (D-lactic acid).

The needle felt and/or the at least one backing layer may comprise 10% or less, preferably 5% or less, more preferably 2% or less by weight or less than 1% by weight of non-biodegradable additives. These non-biodegradable additives may be colorants, filling materials or additives providing particular characteristics to the carpet, such as flame retardation, anti-microbial characteristics, custom smell, UV resistance etc. The active compounds of such additives is typically not higher than 1 to 2% by weight. However, in accordance with the present invention, preferably biodegradable additives are to be used for obtaining the desired characteristics.

According to some embodiments of the present invention, the polymeric biodegradable material of the needle felt may have a melting temperature in the range of 145° C. to 225° C. According to embodiments of the present invention, the polymeric biodegradable material of the at least one backing layer may have a melting temperature in the range of 100° C. to 155° C.

According to some embodiments of the present invention, the polymeric biodegradable material of the needle felt may comprise poly lactic acid. Possibly, the polymeric biodegradable material of the needle felt may consist of poly lactic acid.

According to embodiments of the present invention, the poly lactic acid of the biodegradable polymeric material of the needle felt may comprise or may consist of poly (L-lactic acid). As an alternative, the poly lactic acid of the biodegradable polymeric material of the needle felt may consist of a mixture of poly (L-lactic acid) and poly (D-lactic acid).

According to some embodiments of the present invention, the polymeric biodegradable material of the at least one backing layer may comprise poly lactic acid. The polymeric biodegradable material of the at least one backing layer may consist of poly lactic acid

According to some embodiments of the present invention, the poly lactic acid of the biodegradable polymeric material of the at least one backing layer may comprise poly (D-lactic acid), hereafter D-PLA. The poly lactic acid of the biodegradable polymeric material of the at least one backing layer may consist of poly (D-lactic acid) or may consist of a mixture of poly (D-lactic acid) and poly (L-lactic acid), which poly (L-lactic acid) hereafter may be referred to as L-PLA.

In a second aspect, the present invention provides a method for making a needle punch carpet, comprising: providing a needle felt comprising at least 90%, preferably at least 95%, more preferably at least 98% or even at least 99% and most preferably 100% by weight of a first polymeric biodegradable material, and applying onto the needle-felt at least one backing layer comprising at least 90%, preferably at least 95%, more preferably at least 98% or even at least 99% and most preferably 100% by weight of a second polymeric biodegradable material. The first polymeric biodegradable material may have at least one physical property which is different from the corresponding physical property of the second polymeric biodegradable material, for example the first and the second polymeric biodegradable material may have different melting points

The first polymeric biodegradable material may have a melting temperature T1 being different, such as at least 10° C. higher than the melting temperature T2 of the second polymeric biodegradable material.

The first polymeric biodegradable material may be poly (L-lactic acid), and the second polymeric biodegradable material may be poly (D-lactic acid). These have different melting points.

The needle felt and/or the at least one backing layer may comprises 10% or less, preferably 5% or less, more preferably 2% or less by weight or 1% or less by weight of non-biodegradable additives. These non-biodegradable additives may be colorants, filling materials or additives providing particular characteristics to the carpet, such as flame retardation, anti-microbial characteristics, custom smell etc. The active compounds of such additives is typically not higher than 1 to 2% by weight. In accordance with the present invention, preferably fully biodegradable additives are to be used.

Providing a needle felt comprising a first polymeric biodegradable material may comprise providing a fibre web comprising the first polymeric biodegradable material, and mechanically bonding the fibre web into the needle-felt.

Applying at least one backing layer may comprise providing the second polymeric biodegradable material, melting the second polymeric biodegradable material, and applying the second polymeric biodegradable material onto the needle-felt. The second polymeric biodegradable material may be applied onto the needle-felt before melting it. The method may furthermore comprise applying pressure onto the needle-felt provided with molten second polymeric biodegradable material.

According to embodiments of the present invention, the backing layer may be provided to the needle felt as polymeric biodegradable powder. The polymeric powder may comprise powder particles having an average size in the range of 150 μm to 850 μm, more preferred in the range of 300 μm to 500 μm. According to embodiments of the present invention, the backing layer may be provided according to a weight of 30 g per m² to 130 g per m² needle felt. According to embodiments of the present invention, the needle felt has an average thickness T, the backing layer is present up to a depth in the needle felt, which depth is in the range of 10% to 40% of the average thickness T.

According to some embodiments of the present invention, the difference T1−T2 is larger or equal to 25° C. such as preferably larger or equal to 30° C.

According to some embodiments of the present invention, the polymeric biodegradable material of the needle felt may have a melting temperature in the range of 145° C. to 225° C. Possibly, the polymeric biodegradable material of the needle felt may comprise poly lactic acid. The polymeric biodegradable material of the needle felt may consist of poly lactic acid.

According to some embodiments of the present invention, the poly lactic acid of the biodegradable polymeric material of the needle felt may comprise poly (L-lactic acid). The poly lactic acid of the biodegradable polymeric material of the needle felt may consist of poly (L-lactic acid) or alternatively, the poly lactic acid of the biodegradable polymeric material of the needle felt may consist of a mixture of poly (L-lactic acid) and poly (D-lactic acid).

According to embodiments of the present invention, the polymeric biodegradable material of the at least one backing layer may have a melting temperature in the range of 100° C. to 155° C.

According to some embodiments of the present invention, the polymeric biodegradable material the at least one backing layer may comprise poly lactic acid, or may consist of poly lactic acid.

According to some embodiments of the present invention, the poly lactic acid of the biodegradable polymeric material of the at least one backing layer may comprise poly (D-lactic acid). The poly lactic acid of the biodegradable polymeric material of the at least one backing layer may consist of poly (D-lactic acid), or may consist of a mixture of poly (L-lactic acid) and poly (D-lactic acid).

Particular and preferred aspects of the invention are set out in the accompanying independent and dependent claims. Features from the dependent claims may be combined with features of the independent claims and with features of other dependent claims as appropriate and not merely as explicitly set out in the claims.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 diagrammatically illustrates a compact spinning process, as from the storage of pellets in silos, for producing staple fibres for use in a fibre web according to an embodiment of the present invention.

FIG. 2 diagrammatically illustrates a method for applying a backing layer to a needle-felt, according to an embodiment of the present invention.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term “coupled”, also used in the claims, should not be interpreted as being restricted to direct connections only. Thus, the scope of the expression “a device A coupled to a device B” should not be limited to devices or systems wherein an output of device A is directly connected to an input of device B. It means that there exists a path between an output of A and an input of B which may be a path including other devices or means.

The invention will now be described by a detailed description of several embodiments of the invention. It is clear that other embodiments of the invention can be configured according to the knowledge of persons skilled in the art without departing from the true spirit or technical teaching of the invention, the invention being limited only by the terms of the appended claims.

Needle punch carpets comprise interlocked fibre webs, forming a needle felt, and a backing layer. The base material for a needle punch carpet according to the present invention, both for the fibre webs and for the backing layer, is a synthetic biodegradable material of which polymeric biodegradable material is an example, e.g. making us of a polylactic acid based polymer. The polylactic acid based polymer preferably has extremely good biodegradability characteristics.

The needle felt may be made of a first synthetic, e.g. polymeric biodegradable material, and the backing layer may be made of a second synthetic, e.g. polymeric biodegradable material. Both biodegradable materials have physical characteristics, and at least one physical characteristic of the first polymeric biodegradable material may be different from the corresponding physical characteristic of the second polymeric biodegradable material. For example, the first and the second polymeric biodegradable material may have different melting points, which melting points are at least 10° C. different, i.e. the melting point of the first polymeric biodegradable material being higher than the melting point of the second polymeric biodegradable material

According to the present invention, the needle felt and the backing layer each comprise at least 90%, preferably at least 95%, more preferably at least 98% or even at least 99% and most preferably 100% by weight of biodegradable material. A small amount of non-biodegradable additives may be added, e.g. colorants.

As polymeric biodegradable materials, aliphatic polyesters based on polymerisation of monomers such as glycolic acid (PGA), lactic acid (PLA), butyric acid (PHB), valeric acid (PHV) or caprolactone (PCL) and their copolymers may be used. In particular as polylactic acid based polymers, preferably poly (L-lactic acid) or poly (D-lactic acid) may be used. In a preferred embodiment of the present invention, poly (L-lactic acid) is used for the needle felt, and poly (D-lactic acid) is used for the backing layer. L-lactic acid has a melting point between 180° C. and 200° C., while D-lactic acid has a melting point between 110° C. and 115° C.

The above presentation does not limit itself to the use of PLA-resin as the only “biodegradable” material that can be used with the present invention. Other polymers like Starch polymers e.g. Master-Bi (Novamont), PTT (polytrimethylene terephthalate) from bio-based PDO (1,3 propanediol) or BDO (1,4-Butanediol) e.g. Sorona (DuPont) or Corterra (Shell), PBS (Polybutylene succinate) e.g. Bionelle1000 (Showa Highpolymer), and others could be used as raw material in the scope of the present invention.

Suitable polylactic acid based polymers for making the needle felt and the backing layer of needle punch carpet, are e.g. Ingeo brands like 6202D (type1) and 5200D (type2) respectively, which may be obtained from NatureWorks LLC, Minnesota, USA. The polymers obtained from NatureWorks are in the form of pellets.

Firstly, in an embodiment of the present invention, fibre webs are made from a first polymeric biodegradable material, the fibre webs comprising staple-fibres. In case the first polymeric biodegradable material is provided in the form of pellets, e.g. the first type of pellets, fibre webs may be made as explained hereinafter.

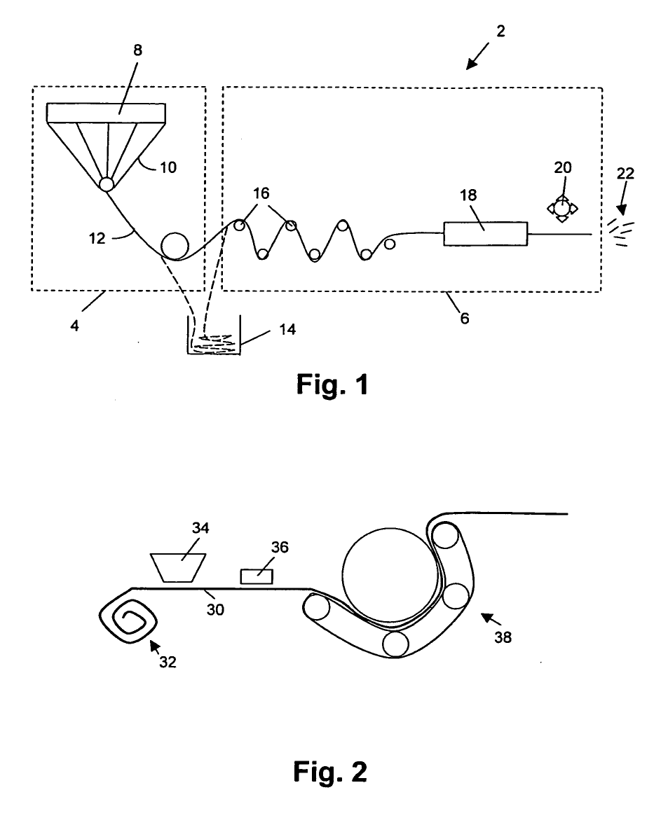

From the pellets of the first polymeric biodegradable material, e.g. the first type of PLA pellets, staple-fibres may be made, either according to a long-spin process or according to a short-spin process. Part of a spinning machine 2 for such long-spin or short-spin process is diagrammatically illustrated in FIG. 1 In both the long-spin and the short-spin process, a first step is spinning 4 of the fibres used for making the staple-fibres, and a further step is stretching 6 and possibly relaxing of the fibres.

When producing staple-fibres, pellets of the first polymeric biodegradable material are mixed with colour and/or other additives, and the mixture is then fed to an extruder 3. The granulate from the extruder 3 is molten by means of a heating device 5, and molten polymer is filtered through a filter 7 and flows towards a spinning position, where the molten polymer is pushed through holes in a spinning plate or spinneret 8, e.g. by means of spinning pumps 9. The spinning plate 8 is a plate or block with a large number of small holes. After the polymeric material has been pushed through the holes of the spinning plate 8, filaments 10 of polymer are obtained which need to solidify. Solidification may e.g. be obtained by cooling. A spin-finish may be applied to the filaments 10 by means of an application device 11. The plurality of filaments 10 is brought together to form a cord 12. In the long spin process, the cord 12 is guided towards a can (not shown in FIG. 1) where it is temporarily stored before being stretched. In the short spin process, the cord 12 is immediately stretched after being spun. Stretching of the cord 12 is carried out to fix its eventual characteristics (tensile strength, denier, strain at failure and shrinkage). For stretching, the cord 12 made from the combined filaments 10 passes over a plurality of stretch rolls 16 which turn faster the farther they are away from the spinning plate 8. Stretching is preferably done under heating, e.g. in a stretching oven 17. After stretching, the cord 12 is texturised by means of e.g. a stufferbox 15. Here crimps are given to the fibre in order to get its textile character. The stretched and textured cord 12 is then relaxed in a relaxation means 18 in order not to show a too high shrinkage when heated afterwards or during subsequent storage. After relaxation, the cord 12 is cut into fibres 22 by any suitable cutting device 20, e.g. by means of a rotating disc provided with knives. The length of the fibres 22 produced depends on the distance between the knives on the rotating disc. The fibres 22, after being cut, may be packed into bales.

The applicant has shown that polylactic acid based polymer fibres 22, in particular poly (L-lactic acid), obtained by both the short spin process and the long spin process have the required characteristics for needle punch carpet, i.e. the fibres have a strength of at least 2 cN/dtex, e.g. 2.5 cN/dtex and an elongation of at least 35%, preferably at least 40%, e.g. 50%, in order not to break during mechanical manipulation further in the process. Other characteristics can be specified like number of crimps, e.g. typically about 3 to 4 crimps/cm, thermostability of the crimp, e.g. typically max. 3% for 5 min at 110° C., spin-finish level on the fibre, e.g. typically between 0.15 and 0.45 m %+/−15%, moisture content, denier, e.g. 3.3 to 110 denier, length, e.g. between 40 and 120 mm.

Biodegradable fibers made from a mixture of L-PLA and D-PLA may be provided having a melting temperature of about 150° C.

From the fibres 22 obtained, fibre webs and needle felt are formed according to any suitable method known in the art.

Secondly, the needle felt formed from the fibre web made with the first polymeric biodegradable material, is made stronger. For that reason, as known in the art, a backing layer is provided. According to embodiments of the present invention, this backing layer may be made from a second polymeric biodegradable material e.g. made from the second type of pellets obtainable from NatureWorks LLC.

This may be done as explained hereinafter, and is illustrated in FIG. 2.

Needle felt 30 of the first polymeric biodegradable material is provided, for example on a roll 32. The second polymeric biodegradable material may be provided in powder form, e.g. pellets of the second type may be ground. Preferably, in order to provide sufficient penetration of the powder particles and thus the secondary backing in the felt 30, the particle size of the powder is to be chosen in a small range, i.e. preferably in of less than 850 μm, as an example between 150 μm and 850 μm, e.g. 300 μm. Such fineness may be obtained by crushing or cutting raw biodegradable polymer material in cryogenic environment. As an example, lactic acid polymer powder, being 100% D-PLA powder of about 300 μm average particle size may be used, which powder has a melting temperature of 115° C. Alternatively a powder of lactic acid polymer made from a mixture of L-PLA and D-PLA having a particle size of 300 μm is used.

Possibly a mixture of such biodegradable powder and additional fillers such as chalk or glass may be used. The chalk is used to increase the weight of the backing layer, and hence of the whole needle punched carpet. Chalk further does not have any influence on the biodegradability of the needle punched carpet.

The powder of the second polymeric biodegradable material may be provided in a container 34, which is able to distribute the powder over the needle felt 30, possibly mixed with a small amount of additives such as colorants, e.g. less than 2% by weight. Preferably an amount of 30 μm² to 1030 g per m² needle felt is provided, e.g. 150 g/m² The powder distributed over the needle felt 30 is heated in a next step, by heating means 36 such as e.g. by non-contact heaters such as convection or radiation heaters. IR heaters are an example of the latter. Heating the powder of the second polymeric biodegradable material is preferably performed at a temperature high enough to melt the second biodegradable material, but low enough in order not to melt the first biodegradable material. In case of the first and second biodegradable material respectively being L-lactic acid and D-lactic acid, the heaters may melt the powder of D-lactic acid up to a temperature below 170° C., preferably up to a temperature of between 110° C. and 115° C. This will result in melting of the D-lactic acid. The molten second polymeric biodegradable material and the needle felt of the first polymeric biodegradable material are then brought in intimate contact with each other, e.g. by means of a calander 38, so as to unite them under pressure. After cooling, a needle felt web of a first biodegradable material, provided with a backing layer of a second biodegradable material is obtained, or thus a needle punch carpet in accordance with the present invention. In particular the needle punch carpet may comprise a needle felt comprising L-lactic acid and a backing layer comprising D-lactic acid.

It was found that the powder, having its lower melting temperature and preferably having a smaller average particle size, enables to obtain a better penetration of powder, before and/or during the melting step the process. Due to the melting temperature difference, the powder may meld while the fibers in the needle felt are affected to a far less extent by the increased temperature. This results in both a good anchoring of the backing layer in the needle felt, whereas the textile touch of the needle felt at its side away from the backing layer remains substantially unaffected.

A needle punch carpet completely or substantially completely formed of biodegradable materials is provided by the present invention. In particular a needle punch carpet comprising a first biodegradable material, e.g. L-lactic acid, as the fibre web or needle felt layer and a second biodegradable material, e.g. D-lactic acid, as the backing layer may be provided.

As an alternative embodiment of a needle punched carpet as subject of the present invention, a carpet is provided in a substantially similar way using a needle felt of fibers made from a mixture of L-PLA and D-PLA having a melting temperature of 150° C. and having a fineness in the range of 2.8 to 33 tex, such as 5.5 tex of 6.7 tex. The fibers have an average length of 40 mm to 90 mm such as 75 mm. The needle felt has a thickness of about 3 mm and a weight per surface of 450 g/m². The backing layer is provided from biodegradable powder of a mixture of L-PLA and D-PLA and having a melting temperature of 115° C. The used particle size of the powder was 500 μm and 150 g/m² of needle felt was provided. Heating the powder to a temperature of 125° C. to 130° C. and calendering the molten powder provided a penetration of the powder up to a depth of about 10% of the thickness of the needle felt.

As a further embodiment of the present invention, the biodegradable needle punched carpet can be subjected in a further process step to a singing operation on the face side of the carpet. Singing the face side provide this face side with small melt balls or nobs, resulting from partially melting the fibers present on this face side. Some fibers may melt together forming relatively coarse nobs of about 5 (+/−2) mm on average in length and 3 (+/−1) mm in width, whereas other fibers may melt and shrink individually, resulting in fine melt balls, i.e. in a range of 0.3 mm to 2.3 mm diameter. The melt balls remain coupled to the needle punched carpet by the not molten part of the fibers, which still are entangled and fixed in the carpet. Such singig may be applied to the whole face surface of the carpet, e.g. in case the carpet is used as door mat. Alternatively, a wall-to-wall needle punched carpet may only be singed locally, providing only a part of the face surface with melt balls.

These melt balls provide the face side of the carpet with a grinding property, which makes it useful for cleaning shoes and alike.

The advantage is that this singing operation can be done very easily, and the resulting carpet, one filled with dirt, can be disposed easily and without causing harm to the environment, seen its biodegradable property. It has also the advantage that the cleaning property can be obtained using fibers having a small fineness, i.e. in the range of 2.8 tex to 33 dtex, so providing the aesthetic advantages of the fine fibers, while providing the cleaning property of coarse fibes

As an example, the needle punched carpet as set out above was subjected to a singeing operation at a temperature of 500° C. to 900° C. during 0.2 sec to 0.6 sec using an open flame gas burning device.

A needle punched carpet having improved cleaning properties was obtained.

If polylactic acid based polymers are used for the first and second biodegradable materials, a needle punch carpet made with such materials may undergo a two-step degradation process. First, the moisture and the heat in the compost pile attacks the polylactic acid polymer chains and splits them apart, creating smaller polymers, and finally, lactic acid. Micro-organisms in compost and soil consume the smaller polymer fragments and lactic acid as nutrients. Since lactic acid is widely found in nature, a large number of organisms metabolise lactic acid. At a minimum, fungi and bacteria are involved in PLA degradation. The end result of the process is carbon dioxide, water and also humus, a soil nutrient. This degradation process is temperature and humidity dependent. For instance, at a temperature of 60° C. and 90% relative humidity, the carpet may be composted in 50 days. The introduction of natural enzymes may accelerate the biodegradation process.

It is to be understood that although preferred embodiments, specific constructions and configurations, as well as materials, have been discussed herein for devices according to the present invention, various changes or modifications in form and detail may be made without departing from the scope and spirit of this invention. For example, the present invention is not limited to the polylactic acid polymers defined above. Other biodegradable polymers may also be used. Furthermore, the biodegradable polymers used may be mixed with other biodegradable materials, such as e.g. wool, paper, sisal, coir, jute, hemp, cotton, hair, flax or seagrass.

1. Needle punch carpet comprising a needle felt and at least one backing layer, wherein both the needle felt and the at least one backing layer comprise at least 90%, by weight of polymeric biodegradable material, the needle felt comprising a first polymeric biodegradable material and the backing layer comprising a second polymeric biodegradable material, the first polymeric biodegradable material having a melting point T1, said T1 being at least 10° C. higher than the melting point T2 of the second polymeric biodegradable material.

2. Needle punch carpet according to claim 1, wherein said backing layer is formed by melting polymeric biodegradable powder.

3. Needle punch carpet according to claim 1, wherein the difference T1−T2 is larger or equal to 25° C.

4. (canceled)

5. Needle punch carpet according to claim 1, wherein the needle felt has an average thickness T, the backing layer is present up to a depth in the needle felt, which depth is in the range of 10% to 40% of the average thickness T.

6. (canceled)

7. Needle punch carpet according to claim 1, wherein the polymeric biodegradable material of the needle felt has a melting temperature T1 in the range of 145° C. to 225° C.

8. Needle punch carpet according to claim 1, wherein the polymeric biodegradable material of the needle felt comprises poly lactic acid.

9. Needle punch carpet according to claim 8, wherein the polymeric biodegradable material of the needle felt consists of poly lactic acid.

10-12. (canceled)

13. Needle punch carpet according to claim 1, wherein the polymeric biodegradable material of the at least one backing layer has a melting temperature in the range of 100° C. to 155° C.

14. Needle punch carpet according to claim 1, wherein the polymeric biodegradable material of the at least one backing layer comprises poly lactic acid.

15. Needle punch carpet according to claim 14, wherein the polymeric biodegradable material of the at least one backing layer consists of poly lactic acid.

16-18. (canceled)

19. A method for making a needle punch carpet, comprising the steps of:
providing a needle felt comprising at least 90% by weight of a first polymeric biodegradable material, said first biodegradable material having a melting temperature T1, and
applying at least one backing layer comprising at least 90% by weight of a second polymeric biodegradable material onto the needle-felt, said second biodegradable material having a melting temperature T2, T1 being at least 10° C. higher than T2.

20. The method for making a needle punch carpet according to claim 19, wherein said backing layer is provided to said needle felt as polymeric biodegradable powder.

21. The method for making a needle punch carpet according to claim 20, wherein said polymeric powder comprises powder particles having an average size in the range of 150 μm to 850 μm.

22. The method for making a needle punch carpet according to claim 19, wherein the difference T1−T2 is larger or equal to 25° C.

23-25. (canceled)

26. The method for making a needle punch carpet according to claim 19, wherein providing a needle felt comprising a first polymeric biodegradable material comprises
providing a fibre web comprising the first polymeric biodegradable material, and mechanically bonding the fibre web into a needle-felt.

27. The method for making a needle punch carpet according to claim 19, wherein the second polymeric biodegradable material is applied onto the needle-felt before melting it.

28. The method for making a needle punch carpet according to claim 19, furthermore comprising, applying pressure onto the needle-felt provided with molten second polymeric biodegradable material.

29-40. (canceled)
